(19) United States
(12) Patent Application Publication
(10) Pub. No.: US 2008/0223807 A1
(43) Pub. Date: Sep. 18, 2008

(54) COLLAR FOR LIQUID AND MEDICINE DISPENSING BOTTLE

(75) Inventor: Lynne Botts, Loveland, OH (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: Blaine Company, Inc. d/b/a Blaine Pharmaceutical, Ft. Wright, KY (US)

(21) Appl. No.: 11/686,557

(22) Filed: Mar. 15, 2007

(51) Int. Cl. A61J 9/00

(52) U.S. Cl. 215/11.1

(57) ABSTRACT

A collar is provided for use with a bottle. The collar includes an annular ring and a flange extending inward from an upper end of the annular ring. There are at least two projections extending outward from an inner surface of the annular ring. The flange of the collar covers a flange of a nipple for the bottle, and the collar projections interlock with outwardly extending projections on a surface of the bottle to secure the nipple to the bottle using about one half of a turn or less.

### BACKGROUND OF THE INVENTION

The present invention relates to a medicine dispensing bottle, and more particularly, to a medicine dispensing bottle with an improved connection between the collar and the bottle.

It is well known in the art that many pharmaceuticals and drugs are provided in liquid form for ease of oral administration to patients such as infants. However, such oral medications generally have an unpleasant or bitter taste which is objectionable to infants. Consequently, many infants will spit the medication out, making it difficult to determine whether the correct dosage has been administered.

Various modified oral compositions as well as devices have been proposed in the prior art to overcome the taste problems associated with conventional dosage forms. For example, Burchett et al, U.S. Pat. Nos. 5,383,906 and 5,487,750, and 5,824,012 teach a nursing bottle in which a syringe is mounted within the bottle for dispensing medication. However, there is open communication through the annular space between the nipple and the interior of the bottle. This could allow the medication to become mixed with the liquid in the bottle, leading to unwanted dilution of the medication in the bottle and inaccurate dosing.

Liu et al., U.S. Pat. No. 5,353,964 teaches a nursing bottle which includes an outer bottle with a detachable nipple and an inner bottle disposed inside the outer bottle. The bottle includes a switch which allows fluid in either bottle to flow into the nipple or to let fluids from both bottles flow into the nipple simultaneously. However, the nipple does not provide an isolated pathway for the medication, and there is no control over the rate of drug delivery. Further, the switch is comprised of three separate parts which may become lost or broken during use.

More effective systems are found in U.S. Pat. Nos. 5,244,122, 6,126,679, and 6,270,519, all of which are incorporated herein by reference. The patents disclose a medicine dispensing bottle which comprises a traditional nursing bottle having an internal receptacle which accommodates a syringe for dispensing medicine. The bottle allows regulated dispensing of medicine along with other liquids commonly ingested by an infant, such as milk or juice, through separate holes in the nipple attached to the bottle. The nipple includes a medicine tube which is in communication with at least one of the holes in the nipple. The medicine tube attaches to the receptacle so that medicine can flow from the receptacle through the medicine tube and out the hole in the nipple. The medicine and liquid can enter the infant's mouth simultaneously, thereby effectively masking the taste of the medicine while obtaining accurate dosing of the medicine.

The collar which connects the nipple to the bottle described in these patents is a traditional threaded collar which screws onto the threaded mouth of the bottle. In some situations, we have found that the medicine tube can twist as the collar is screwed onto the bottle due to the snug fit of the end of the receptacle in the medicine tube. The twisting can partially or completely block off the supply of medicine from the syringe. Twisting of the nipple can also break the seal between the medicine tube in the nipple and medicine channel inside the bottle, causing medicine to mix with the bottle fluids.

Accordingly, there is a need in the art for an improved collar for connecting the nipple to a medicine dispensing bottle.

### SUMMARY OF THE INVENTION

The present invention meets that need by providing an improved collar for a liquid and medicine dispensing bottle. The collar includes an annular ring and a flange extending inward from the upper end of the annular ring. There are at least two projections extending outward from the inner surface of the annular ring. The flange of the collar covers the flange of the nipple for the bottle, and the collar projections interlock with outwardly extending projections on a surface of the bottle to secure the nipple to the bottle using about one half of a turn or less.

The collar can be used with a liquid and medicine dispensing bottle including a bottle having an open end, and at least two projections extending outward from the outer surface of the bottle near the open end; a nipple comprising a body portion, an open end having an annular flange which is attached to the open end of the bottle, and a discharge end including at least one opening; the nipple further including a medicine tube disposed in the body portion of the nipple, which is in communication with the at least one opening; a medicine receptacle disposed within the bottle and removably fitted to the medicine tube for dispensing medicine through the at least one opening of the nipple; wherein the nipple permits medicine and other liquids from the bottle to be dispensed into an infant's mouth separately or simultaneously.

### BRIEF DESCRIPTION OF THE DRAWINGS

FIG. 1 is a cross-sectional view showing a medicine dispensing bottle.

FIG. 2 is a rear elevational view of one embodiment of a nipple for the bottle.

FIG. 2A is a cross-sectional view of an alternate embodiment of a nipple.

FIG. 3 is a cross-sectional view of the inside of one embodiment of a collar of the present invention;

FIG. 4 is a bottom plan view of the collar of FIG. 3.

FIG. 5 is a perspective view of the collar of FIG. 3.

FIG. 6 is a side view of one embodiment of the bottle of the present invention.

FIG. 7 is a top plan view of the open end of the bottle of FIG. 5.

FIG. 8 is a portion of the side view of open end of the bottle.

FIG. 9 is a cross-section of the connection between the collar and the bottle.

### DETAILED DESCRIPTION OF THE INVENTION

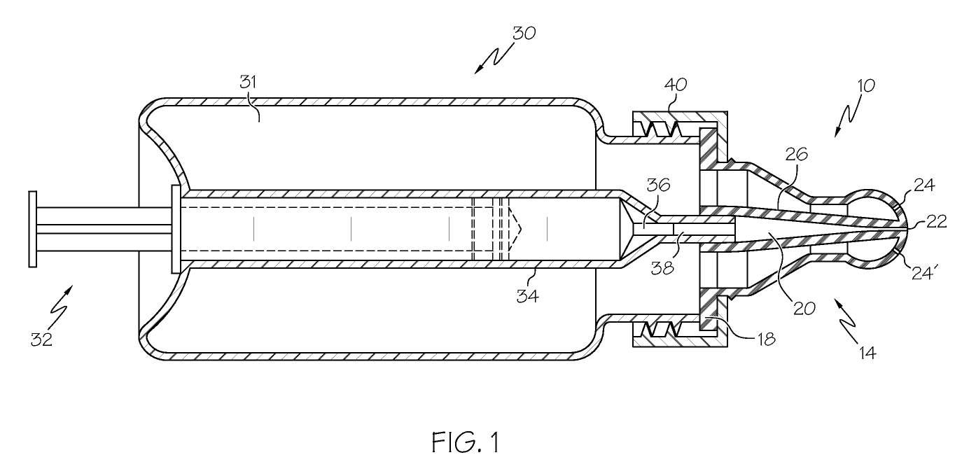

The basic system is described in U.S. Pat. Nos. 5,244,122, 6,126,679, and 6,270,519. FIG. 1 illustrates one embodiment of such a bottle. The bottle 30 includes an inner reservoir 31 for holding liquids such as juice or formula and a receptacle 34 which houses a syringe assembly 32 which is used to dispense medicine into the nipple.

As shown, the annular flange 18 of the nipple and the nipple tube connected to the webbed membrane 26 aid in sealing the bottle when the nipple is secured to the bottle via a conventional collar 40 which screws onto the threaded mouth of the bottle. When the nipple 10 is secured to the bottle, medicine can pass from the receptacle 34 to the medicine tube 20 without escaping into the liquid contents of reservoir 31 because the receptacle end 38 forms a snug fit within the medicine tube 20. If desired, the end of the medicine tube 20 which contacts the receptacle end 38 may include an annular flange, or an O-ring or notch (not shown) which is designed to slip over the medicine receptacle and aid in forming a fluid tight seal.

In use, liquid, such as juice or formula, may be contained in the reservoir 31. When an infant engages in sucking the liquid from reservoir 31 of the bottle, the liquid exits the nipple through openings 24 and 24′. As the infant is sucking the liquid, the syringe 32 is used to slowly inject medicine into receptacle end 38 and medicine tube 20 into the infant's mouth via opening 22. Thus, the medicine becomes mixed in the infant's mouth with the juice or formula, effectively masking the taste of the medicine. It should be appreciated that while the nipple allows simultaneous dispensing of liquid and medicine, it is also possible to dispense the liquid and medicine separately, i.e., the liquid in the bottle may be dispensed without the medicine, and the medicine may be administered without any other liquid in the bottle.

It should also be appreciated that, while it is preferred that the medicine and liquid exit the discharge end through separate openings, it is possible that the medicine and liquid may be provided from separate sources (not shown) into medicine tube 20 such that the medicine and liquid are provided simultaneously through a single opening 22.

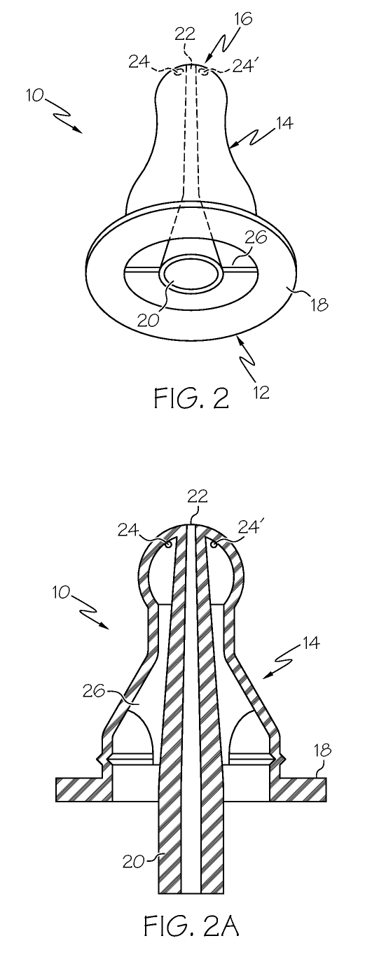

Examples of some embodiments of nipples for use in the system are shown in FIGS. 2 and 2A. The nipple 10 comprises an open end 12 which includes an annular flange 18 for attachment to a bottle, a body portion 14, and a discharge end 16 which, in the embodiment shown, includes three discharge openings 22, 24 and 24′. The openings may be provided in any shape or form such as holes, slits, etc. and may have varying positions on the discharge end. A medicine tube 20 is disposed within the nipple body portion 14 and preferably extends from the open end of the nipple, tapering inward toward the discharge end 16.

One end of the medicine tube 20 is in communication with opening 22 in the discharge end 16 of the nipple 10. As shown, the medicine tube 20 is connected to the inner body portion of the nipple by a webbed membrane 26. The webbing may be included on one side of the medicine tube 20 or both sides.

In an alternative embodiment shown in FIG. 2A, the medicine tube 20 may extend beyond the open end of the nipple. It should be appreciated that the length and diameter of the medicine tube may vary, depending on the desired use for the nipple. Also as shown in FIG. 2A, the webbed membrane 26 may be tapered inward toward the open end of the nipple. Other embodiments of suitable nipples are shown in U.S. Pat. Nos. 6,126,679, and 6,270,519.

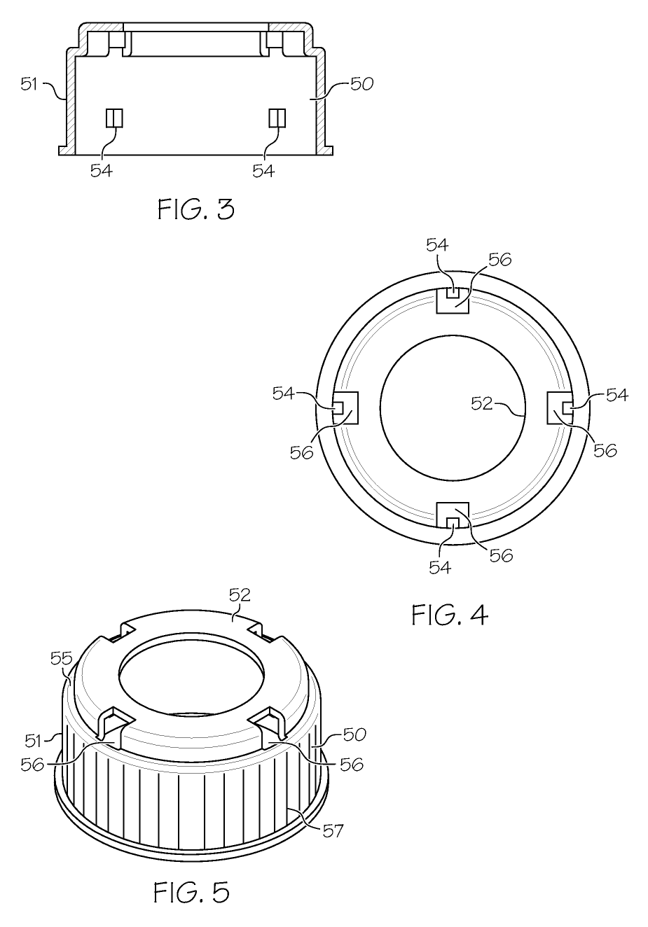

The use of a threaded connection to secure the nipple to the bottle, as described in U.S. Pat. Nos. 5,244,122, 6,126,679, and 6,270,519, can cause the medicine tube to twist as the collar is turned, which can partially or completely block off the supply of medicine from the syringe. Twisting of the nipple can also break the seal between the medicine tube in the nipple and medicine channel inside the bottle, causing medicine to mix with the bottle fluids. In order to solve this problem, a new connection between the collar and bottle was developed. One embodiment of the collar is shown in FIGS. 3-5. The collar 50 has an annular ring 51 with an inwardly extending flange 52 at the upper end. The flange 52 covers the flange of the nipple when the collar is attached to the bottle, holding the nipple in place.

The collar 50 has collar projections 54 on the inside surface. The collar projections 54 extend inward. There are generally at least two projections, typically three or four, although there could be more if desired. The collar projections are approximately equally spaced around the inside collar. The collar projections are generally on the order of about 2-5 mm in length and width and about 1-2 mm in depth, although they could be larger or smaller if desired. The collar projections must be large enough to provide a secure connection between the collar and bottle. They can be any suitable shape, including, but not limited to square, rectangular, or circular.

The collar 50 can optionally include a shoulder 55 at the upper end of the annular ring 51. The shoulder 55 provides a seat for a cap to cover the nipple (not shown).

The collar 50 can optionally include openings 56 in the shoulder 55 and the flange 52. The openings 56 correspond to the location of the collar projections 54 on the inside of the collar. The openings may be needed for manufacturing purposes, depending on the process used to make the collar.

The collar 50 can have ridges 57 on the outer surface of the annular ring. The ridges 57 help the user to hold the collar when rotating the collar and/or bottle to secure the nipple to the bottle.

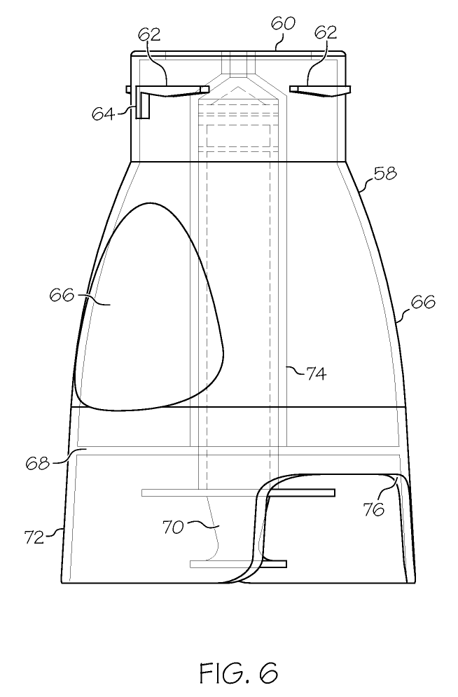

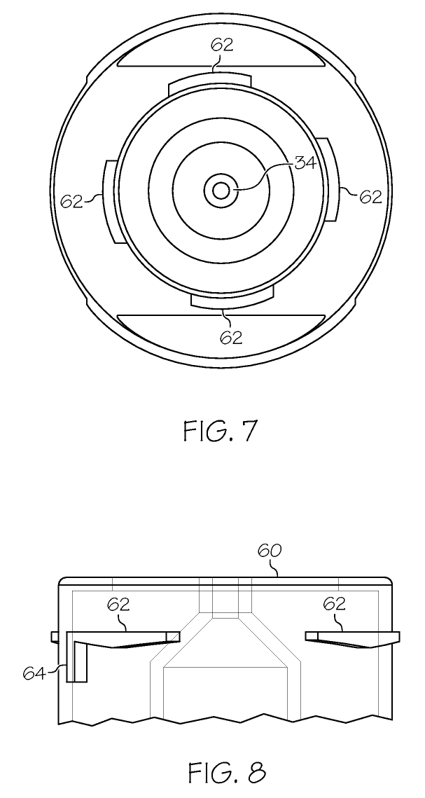

One embodiment of the bottle is shown in FIGS. 6-8. The bottle 58 has an open end 60. The bottle projections 62 extend outward from the outside of the bottle's surface near the open end 60. There are generally at least two bottle projections, typically three or four, although more can be used if desired. There will typically be the same number of bottle projections as there are collar projections. The bottle projections are approximately equally spaced around the outside of the bottle. The bottle projections 62 are typically longer than the collar projections 54, although they could be of similar size if desired. When four bottle connectors are used on a standard bottle, the bottle projections are typically in the range of about 10-15 mm in length, 1-2 mm in width and 1-2 mm in depth. In this arrangement, each bottle projection covers approximately one eighth of the circumference of the bottle.

The bottle projections 62 can be formed so that the middle of the bottle projection is wider than the ends. This arrangement is desirable because it helps to prevent inadvertent rotation and release of the collar. The bottle projection can be substantially in the shape of an inverted triangle with the point facing the bottom of the bottle, for example. Alternatively, the bottle projection can be in the shape of a half circle or a half ellipse, or other suitable shape.

There can be a stop 64 on the bottle 58. The stop 64 prevents the collar projection 54 from rotating past the end of the bottle projection 64 and releasing the collar. The stop 64 can be part of the bottle projection 62 as shown. Alternatively, in some arrangements, the stops could be separate from the bottle projections. There can be one or more stops 64.

The collar projections are typically smaller than the bottle projections for ease of use. By providing a relatively large space between the bottle projections (approximately one eighth of the circumference of the opening (about 15 mm for a standard bottle)) and collar projections which are much smaller than that space (2-5 mm), the alignment between collar and bottle is quite easy. As the size of the collar projections increases, more careful attention must be paid to proper alignment because there is less space between the collar projections and bottle projections.

Alternatively, the larger projections could be placed on the inside of the collar, and the smaller projections could be on the bottle.

Depending on the number of interlocking collar and bottle projections, the rotation required to connect the collar to the bottle is typically about one half turn or less, or about one third turn or less, or about one quarter turn or less, or about one eighth turn or less. Using four bottle projections each covering approximately one eighth of the circumference of the opening, about one eighth of a turn or less is used to make the connection.

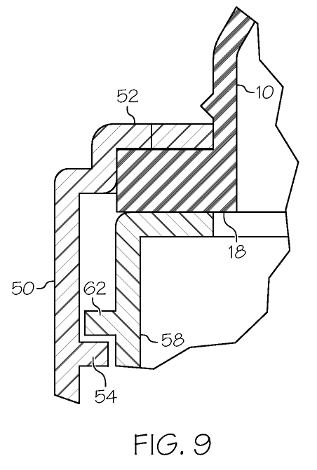

To attach the nipple to the bottle, the collar 50 is placed over the bottle 58 and the flange 18 of the nipple 10. The collar projections 54 are positioned between the bottle projections 62 until the collar reaches the flange 18 of the nipple 10. The collar 50 and/or the bottle 58 are rotated so that the collar projections 54 engage the bottle projections 62. The collar 50 is rotated until the collar projections 54 engage the stops 64. This provides a secure liquid tight seal between the collar 50 and the bottle 58, as shown in FIG. 9. The flange 18 of nipple 10 is held between the flange 52 of the collar and the top of the bottle 58 by the interlocking collar projections 54 and bottle projections 62.

As shown in FIG. 6, there can be at least two substantially flat portions 66 on the outer surface of the bottle 58 for gripping the bottle during rotation of the bottle and/or collar when the nipple is secured to the bottle and for ease of holding the bottle during use.

The bottom 68 of the bottle 58 can be substantially flat as shown in FIG. 6. The substantially flat bottom 68 allows easy access to the syringe assembly 70 for insertion and removal. The bottle 58 can optionally include a skirt 72 which extends downward from the bottom 68 of the bottle 58. The skirt 72 will typically be an extension of the sidewall of the bottle. The skirt 72 extends downward from the bottom 68 of the bottle 58 a distance greater than the syringe assembly 70 extends outward from the receptacle 74. The bottom of the skirt 72 provides a secure base on which the bottle 58 can stand, even when the syringe assembly 70 is in place. The skirt 72 can extend all the way around the bottle 58, if desired. Alternatively, the skirt 72 can extend only part of the way around the bottle 58, leaving one or more openings 76. The openings 76 allow easier access to the syringe assembly 70 for insertion and removal.

While certain representative embodiments and details have been shown for purposes of illustrating the invention, it will be apparent to those skilled in the art that various changes in the methods and apparatus disclosed herein may be made without departing from the scope of the invention, which is defined in the appended claims.

What is claimed is:

1. A liquid and medicine dispensing bottle comprising:
a bottle having an open end, and at least two projections extending outward from an outer surface of the bottle near the open end;
a nipple comprising a body portion, an open end having an annular flange which is attached to the open end of the bottle, and a discharge end including at least one opening; the nipple further including a medicine tube disposed in the body portion of the nipple, which is in communication with the at least one opening;
a medicine receptacle disposed within the bottle and removably fitted to the medicine tube for dispensing medicine through the at least one opening of the nipple; wherein the nipple permits medicine and other liquids from the bottle to be dispensed into an infant's mouth separately or simultaneously; and
a collar comprising an annular ring and a flange extending inward from an upper end of the annular ring, and at least two projections extending outward from an inner surface of the annular ring, wherein the flange of the collar covers the flange of the nipple, and the collar projections interlock with the bottle projections to secure the nipple to the bottle using about one half of a turn or less.

2. The bottle of claim 1 wherein there are four collar projections and four bottle projections.

3. The bottle of claim 1 wherein the collar projections interlock with the bottle projections using about one eighth of a turn or less.

4. The bottle of claim 1 wherein the bottle projections are wider in the middle than at the end.

5. The bottle of claim 1 wherein the collar projections comprise a rectangle and the bottle projections comprise a triangle where a point of the triangle points toward the bottom of the bottle.

6. The bottle of claim 5 wherein at least one of the bottle projections includes a stop.

7. The bottle of claim 1 further comprising a stop on the inside of the collar or on the outside of the bottle.

8. The bottle of claim 7 wherein the stop is part of the collar projection or the bottle projection.

9. The bottle of claim 1 wherein the collar includes a shoulder at the upper end of the annular ring.

10. The bottle of claim 1 wherein the collar includes ridges on the outside of the annular ring.

11. The bottle of claim 1 wherein the outer surface of the bottle has at least two flat portions.

12. The bottle of claim 1 wherein the outer surface of the bottle has a skirt depending downward from the bottom of the bottle, the skirt extending further downward than a syringe assembly in the medicine receptacle so that the bottle can stand on the skirt.

13. A collar for connecting a nipple to a liquid and medicine dispensing bottle, the collar comprising an annular ring and a flange extending inward from an upper end of the annular ring, and at least two projections extending outward from an inner surface of the annular ring, wherein the flange of the collar covers a flange of the nipple, and the collar projections interlock with outwardly extending projections on a surface of the bottle to secure the nipple to the bottle using about one half of a turn or less.

14. The collar of claim 13 wherein there are four collar projections.

15. The collar of claim 13 wherein the collar projections interlock with the bottle projections using about one eighth of a turn or less.

16. The collar of claim 13 wherein the collar projections comprise a rectangle.

17. The collar of claim 12 wherein the collar includes a shoulder at the upper end of the annular ring.

18. The bottle of claim 12 wherein the collar includes ridges on the outside of the annular ring.

19. A liquid and medicine dispensing bottle comprising:
a bottle having an open end, and four projections extending outward from an outer surface of the bottle near the open end;
a nipple comprising a body portion, an open end having an annular flange which is attached to the open end of the bottle, and a discharge end including at least one opening; the nipple further including a medicine tube disposed in the body portion of the nipple, which is in communication with the at least one opening;
a medicine receptacle disposed within the bottle and removably fitted to the medicine tube for dispensing medicine through the at least one opening of the nipple; wherein the nipple permits medicine and other liquids from the bottle to be dispensed into an infant's mouth separately or simultaneously; and
a collar comprising an annular ring and a flange extending inward from an upper end of the annular ring, and four projections extending outward from an inner surface of the annular ring, wherein the flange of the collar covers the flange of the nipple, and the collar projections interlock with the bottle projections to secure the nipple to the bottle using about one eighth of a turn or less.

20. The bottle of claim 19 wherein the collar projections comprise a rectangle and the bottle projections comprise a triangle where a point of the triangle points toward a bottom of the bottle.
